(19) United States
(12) Patent Application Publication
(10) Pub. No.: US 2026/0276596 A1
(43) Pub. Date: Sep. 17, 2026

(54) ARTIFICIAL INTELLIGENCE (AI)-POWERED ULTRASONIC IMAGING OF DEFECTS IN SOLIDS

(71) Applicant: CENTRAL MICHIGAN UNIVERSITY, Mount Pleasant, MI (US)

(72) Inventors: Chanseok Jeong, Mt. Pleasant, MI (US); Boyoung Kim, Mt. Pleasant, MI (US); Sina Tajmiri, Mt. Pleasant, MI (US)

(21) Appl. No.: 19/567,770

(22) Filed: Mar. 16, 2026

Related U.S. Application Data
(60) Provisional application No. 63/773,274, filed on Mar. 17, 2025.

(51) Int. Cl. G01N 29/04; G01N 29/12; G01N 29/44

(52) U.S. Cl. CPC G01N 29/045; G01N 29/12; G01N 29/4481

(57) ABSTRACT

Apparatus and methods for detecting a defect in an object. An example method includes characterizing an excitation force profile and matching a measurement point's location from a surface of the object to a corresponding location in a background mesh. The background mesh has a fixed reference geometry. The method also includes mapping a damage profile of a training data object onto a volume of the training data object's background mesh to generate a binary classification for each of a plurality of grid elements of the background mesh; converting the binary classification into a continuous probability value to generate a training matrix. The method also includes training an artificial neural network (ANN) using a training dataset including the training matrix. The method also includes predicting, via the trained ANN, the defect as a group of damaged elements within the background mesh based on measurement data.

### CROSS-REFERENCE TO RELATED APPLICATIONS

This application claims priority to U.S. Application No. 63/773,274, titled ARTIFICIAL INTELLIGENCE (AI)-POWERED ULTRASONIC IMAGING OF DEFECTS IN SOLIDS, filed Mar. 17, 2025, which is hereby incorporated by reference in its entirety.

### TECHNICAL FIELD

The present disclosure generally relates to non-destructive testing of defects, and more specifically, to systems and methods for detecting structural defects using laser-based measurements and machine learning techniques.

### BACKGROUND

Structural defects such as voids, inclusions, and cracks within materials compromise the integrity of civil and mechanical structures. Non-destructive testing (NDT) methods use ultrasonic waves to examine materials without causing damage, as ultrasonic waves can penetrate into materials under inspection. Conventional ultrasonic scanning-based NDT approaches do not involve systematic numerical methods, and thus take substantial time and rely on skilled technicians for operation. The conventional ultrasonic scanning-based NDT approaches may suit simple scenarios, such as locating a single line crack near a sensing probe in a basic structure of a simple geometry. When ultrasonic scanning is not available, guided wave measurement systems are utilized. Using guided waves allows for the monitoring of extensive structural areas while requiring only a minimal number of sensors. However, in many approaches, these guided wave responses have been used to determine only the presence or absence of damage, without fully resolving its precise location or geometry. Methods using optimization algorithms for defect detection from guided wave measurement take extensive computation time. Methods using machine learning from guided wave measurement only identify circular or elliptical voids of predetermined quantities, limiting detection to specific void shapes with known parameters in simple-shaped solids.

### SUMMARY

Aspects of the present disclosure describe systems and methods that incorporate a fixed background mesh structure maintaining consistency across multiple damage profiles, conversion of binary damage classifications into continuous probability distributions, generation of training matrices capturing diverse damage scenarios, and neural network prediction using measurement data mapped to mesh locations. These aspects provide technical improvements by predicting defects with arbitrary shapes, quantities, and sizes in three-dimensional structures, reducing computational overhead through consistent mesh geometry, and generating predictions without prior assumptions about defect characteristics.

According to examples of the present disclosure, a computer-implemented method for detecting a defect in an object comprises: characterizing an excitation force profile by determining a temporal and spatial distribution of the excitation force profile; matching a measurement point's location from a surface of the object to a corresponding location in a background mesh, wherein the background mesh has a fixed reference geometry; mapping a damage profile of a training data object onto a volume of the training data object's background mesh to generate a binary classification for each of a plurality of grid elements of the background mesh; converting the binary classification into a continuous probability value based on a distance between each of the plurality of grid elements and a damage location within the background mesh to generate a training matrix; training an artificial neural network (ANN) using a training dataset including the training matrix; receiving ultrasonic guided wave measurement data of points from the surface of the object corresponding to locations in the background mesh; and predicting, via the trained ANN, the defect as a group of damaged elements within the background mesh based on the measurement data.

According to examples of the present disclosure, an apparatus for detecting a defect in an object, comprises an electronic processor configured to characterize an excitation force profile by determining a temporal and spatial distribution of the excitation force profile; match a measurement point's location from a surface of the object to a corresponding location in a background mesh, wherein the background mesh has a fixed reference geometry; map a damage profile of a training data object onto a volume of the training data object's background mesh to generate a binary classification for each of a plurality of grid elements of the background mesh; convert the binary classification into a continuous probability value based on a distance between each of the plurality of grid elements and a damage location within the background mesh to generate a training matrix; train an artificial neural network (ANN) using a training dataset including the training matrix; receive ultrasonic guided wave measurement data of points from the surface of the object corresponding to locations in the background mesh; and predict, via the trained ANN, the defect as a group of damaged elements within the background mesh based on the measurement data.

According to examples of the present disclosure, a non-transitory computer-readable medium storing instructions for detecting a defect in an object is described. The instructions when executed by a computer, cause the computer to characterize an excitation force profile by determining a temporal and spatial distribution of the excitation force profile; match a measurement point's location from a surface of the object to a corresponding location in a background mesh, wherein the background mesh has a fixed reference geometry; map a damage profile of a training data object onto a volume of the training data object's background mesh to generate a binary classification for each of a plurality of grid elements of the background mesh; convert the binary classification into a continuous probability value based on a distance between each of the plurality of grid elements and a damage location within the background mesh to generate a training matrix; train an artificial neural network (ANN) using a training dataset including the training matrix; receive ultrasonic guided wave measurement data of points from the surface of the object corresponding to locations in the background mesh; and predict, via the trained ANN, the defect as a group of damaged elements within the background mesh based on the measurement data.

### DESCRIPTION OF THE DRAWINGS

Skilled artisans will appreciate that elements in the figures are illustrated for simplicity and clarity and have not necessarily been drawn to scale. For example, the dimensions of some of the elements in the figures may be exaggerated relative to other elements to help improve understanding of examples of the present disclosure.

The system, apparatus, non-transitory computer-readable medium, and method components have been represented where appropriate by conventional symbols in the drawings, showing only those specific details that are pertinent to understanding the examples of the present disclosure so as not to obscure the disclosure with details that will be readily apparent to those of ordinary skill in the art having the benefit of the description herein.

FIG. 1 illustrates a system for defect detection according to aspects of the present disclosure.

FIG. 2 illustrates an apparatus for defect detection according to aspects of the present disclosure.

FIG. 3 illustrates a computer-implemented method for defect detection according to aspects of the present disclosure.

FIG. 4 illustrates a background mesh and an object according to aspects of the present disclosure.

FIG. 5 illustrates a method for converting binary damage classifications into continuous probability values according to aspects of the present disclosure.

FIG. 6 illustrates an end-to-end defect detection workflow according to aspects of the present disclosure.

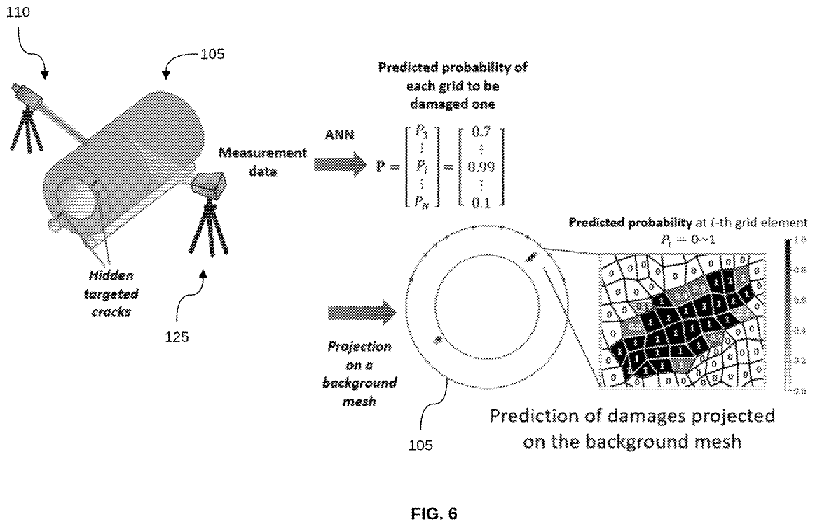

FIG. 7 illustrates a method for training an artificial neural network and predicting defects according to aspects of the present disclosure.

FIGS. 8A and 8B illustrates a comparison of defect detection performance between models trained with noise and models trained without noise according to aspects of the present disclosure.

### DETAILED DESCRIPTION

In the following, various examples, embodiments, aspects, and features are described. However, it is to be understood that the examples, embodiments, aspects, and features may be implemented in different forms and used with different tool sets. The figures presented are not necessarily to scale; some details may be minimized or simplified to show the major steps along the way.

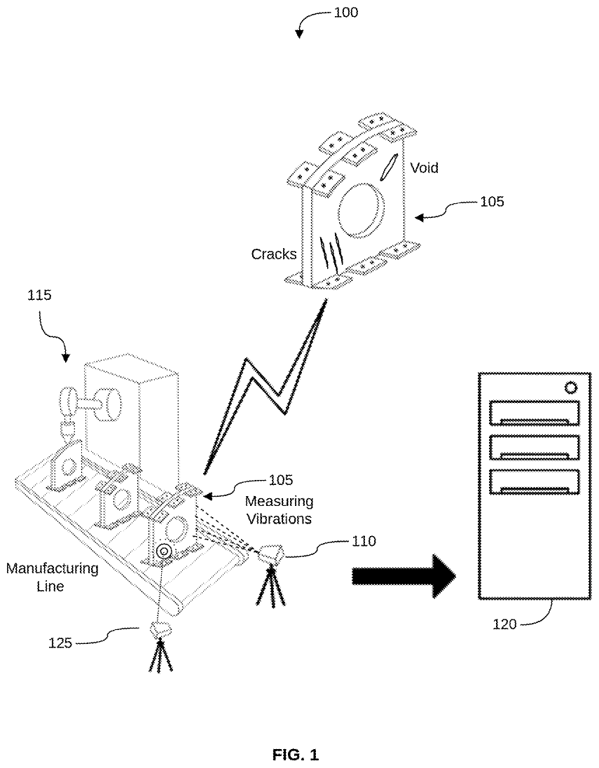

FIG. 1 illustrates a system 100 for defect detection according to aspects of the present disclosure. The system 100 may detect defects in an object using laser-based measurements and automated defect detection processing.

In FIG. 1, an object 105 includes structural defects that are hidden from a surface of the object 105. For example, the object 105 comprises mechanical or civil structures, such as components in an additive manufacturing line. In some instances, the structural defects within the object 105 include voids, cracks, or other internal damage not visible from the surface of the object 105.

A laser vibration source 125, or another contact or non-contact transducer, applies excitation signals at one or more points on the surface of the object 105 to generate wave responses for measurement. A laser Doppler vibrometer (LDV) 110 measures vibrations from the object 105. The LDV 110 may capture point-by-point vibration measurements from multiple locations on the surface of the object 105. In some instances, the LDV 110 performs non-contact measurements of the surface vibrations with high spatial resolution.

In the system 100, a measurement setup process 115 configures and coordinates position of the laser vibration source 125, or another contact or non-contact transducer, and the LDV 110. The measurement setup process 115 involves applying a vibration to the object 105 with the laser vibration source 125, or another contact or non-contact transducer, and collecting wave response data from the object 105 with the LDV 110 in response to the applied vibration. For example, the measurement setup process 115 involves applying a vibration source to generate an excitation signal. In some instances, the measurement setup process 115 applies the laser vibration source 125, or another contact or non-contact transducer, at predetermined locations on the surface of the object 105 to generate a wave response in response to the excitation signal.

In the system 100, a defect detection apparatus 120 processes wave response data from the LDV 110 to identify structural defects within the object 105. The defect detection apparatus 120 receives the wave response data from the LDV 110 and processes the wave response data to detect the structural defects in the object 105. The defect detection apparatus 120 implements signal processing and machine learning techniques to analyze the wave response data. In some instances, the defect detection apparatus 120 generates predictions about locations and characteristics of structural defects within the object 105 based on the processed wave response data. The defect detection apparatus 120 implements an artificial neural network (ANN) for defect detection.

In some examples, the system 100 implements non-destructive testing. For example, the measurement setup process 115 excites the object 105 using the laser vibration source 125, or another contact or non-contact transducer, the LDV 110 measures the resulting vibrations from multiple surface points, and the defect detection apparatus 120 processes these measurements to detect and characterize internal structural defects.

In some examples, the system 100 implements real-time detection of structural defects in manufactured products along production lines. For example, the system performs quality control inspection of parts produced through additive manufacturing processes, identifying internal defects before parts move to subsequent manufacturing stages.

In some examples, the system 100 is used in maintenance inspection across multiple industries including aerospace, automotive, defense, nuclear power, and pipeline applications. In some instances, the system examines aircraft or spacecraft components, automotive parts, defense, nuclear power, or pipeline equipment to detect developing structural defects before failures occur. The non-contact nature of the laser-based measurements allows inspection of components while installed in their operating environments, reducing maintenance downtime and inspection costs.

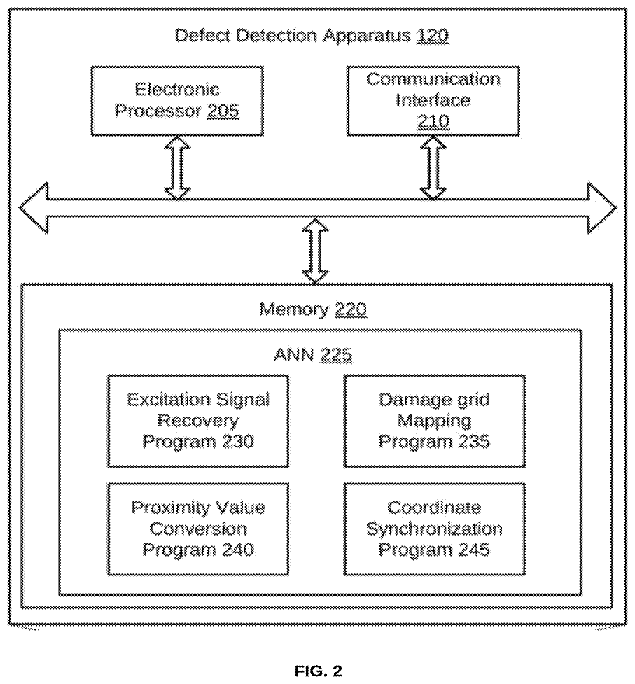

FIG. 2 illustrates a defect detection apparatus 120 according to aspects of the present disclosure. The defect detection apparatus 120 comprises an electronic processor 205, a communication interface 210, and a memory 220. The memory 220 comprises an artificial neural network (ANN) 225 including an excitation signal recovery program 230, a damage grid mapping program 235, a proximity value conversion program 240, and coordinate synchronization program 245.

The electronic processor 205 may include a hardware device, such as a general-purpose processor, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

In some examples, electronic processor 205 is configured to operate a memory array using a memory controller. In other examples, a memory controller is integrated into the electronic processor 205. In some examples, the electronic processor 205 is configured to execute computer-readable instructions stored in the memory 220 to perform various functions. In some aspects, the electronic processor 205 includes special purpose components for modem processing, baseband processing, digital signal processing, or transmission processing.

The communication interface 210 manages the flow of information between the computer system and external devices or users. For example, communication interface 210 handles input from devices such as keyboards, mice, or microphones, and manages output to displays, speakers, or other peripherals. In some examples, communication interface 210 includes a user interface component. The communication interface 210 may include a user interface configured to receive user input indicating the security analysis target, and the user interface may include an access to a threat analysis and risk assessment toolset including a user control button.

The memory 220 includes one or more non-transitory memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of electronic processor 205 to perform various functions described herein.

In some examples, the memory 220 includes a basic input/output system (BIOS) that controls basic hardware or software operations, such as an interaction with peripheral components or devices. In some examples, the memory 220 includes a memory controller that operates memory cells of the memory 220.

The ANN 225 processes information through interconnected nodes organized in layers, similar to biological neural networks. Each node receives input data, applies mathematical transformations, and produces output values that flow to subsequent layers. Through training with example data, the ANN 225 adjusts parameters to recognize patterns and make predictions on new data. In some examples, the ANN 225 may learn to associate measured responses with underlying damage patterns and process wave response data to identify defect characteristics by using one or more of the programs in the ANN 225, including the excitation signal recovery program 230, the damage grid mapping program 235, the proximity value conversion program 240, and coordinate synchronization program 245.

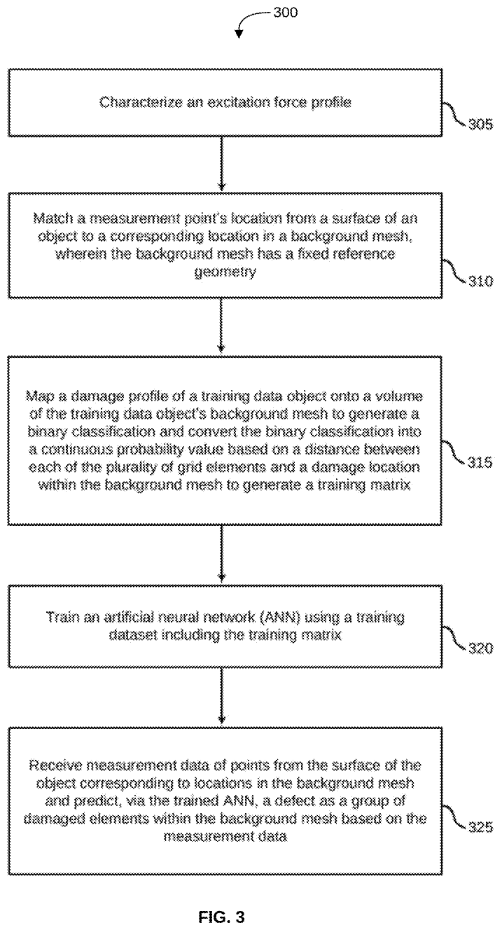

The excitation signal recovery program 230 receives wave response data and determines an excitation force profile. The excitation signal recovery program 230 processes input wave response data measured by the LDV 110 to output the excitation force profile used for damage detection. The operation of the excitation signal recovery program 230 is further illustrated in blocks 305 of FIG. 3, which details the process of obtaining an excitation force profile.

The damage grid mapping program 235 receives the damage profile and maps it onto a background mesh with a fixed reference geometry. The damage grid mapping program 235 processes the damage profile to output binary classifications for grid elements, indicating damaged or undamaged regions. The operation of the damage grid mapping program 235 is further illustrated in block 315 of FIG. 3, which details one or more examples of the mapping process.

The proximity value conversion program 240 converts binary classifications into continuous probability values. The proximity value conversion program 240 processes the binary grid element classifications to output a training matrix based on distances between grid elements and damage locations. The operation of the proximity value conversion program 240 is further illustrated in block 315 of FIG. 3, which details one or more examples of the conversion process.

The coordinate synchronization program 245 processes measurement data points for defect prediction. The coordinate synchronization program 245 receives measurement data from surface points and outputs defect predictions at corresponding locations using a trained artificial neural network. The operation of the coordinate synchronization program 245 is further illustrated in block 310 of FIG. 3, which details one or more examples of the coordinate synchronization processes.

FIG. 3 illustrates a computer-implemented method 300 for defect detection according to aspects of the present disclosure. The computer-implemented method 300 may detect structural defects in an object using an ANN. The computer-implemented method 300 includes characterizing an excitation force profile by determining its temporal and spatial distribution (block 305). The computer-implemented method 300 includes matching measurement point's location from a surface of the object to the corresponding location in the background mesh, wherein the background mesh has a fixed reference geometry (block 310). The computer-implemented method 300 includes mapping a damage profile of an object for a training onto a volume of the object's background mesh to generate a binary classification for each of a plurality of grid elements of the mesh. The computer-implemented method 300 includes converting the binary classification into a continuous probability value based on a distance between each of the plurality of elements and a damage location within the background mesh to generate a training matrix (block 315). The computer-implemented method 300 includes training an artificial neural network (ANN) using a training dataset including the training matrix (block 320). The computer-implemented method 300 includes receiving measurement data of points from a surface of the object corresponding to locations in the background mesh. The computer-implemented method 300 includes predicting, via the trained ANN, the defect as a group of damaged elements within the background mesh based on the measurement data (block 325).

In FIG. 3, operations of the block 305 includes characterizing an excitation force profile. For example, the operations of the block 305 may include applying an excitation signal to the object and processing wave response data to characterize an excitation force profile. The excitation force profile can be generated using machine learning or a full-waveform source inversion to iteratively adjust predicted wave responses and minimizes differences between the predicted wave responses and the measured wave response from the object.

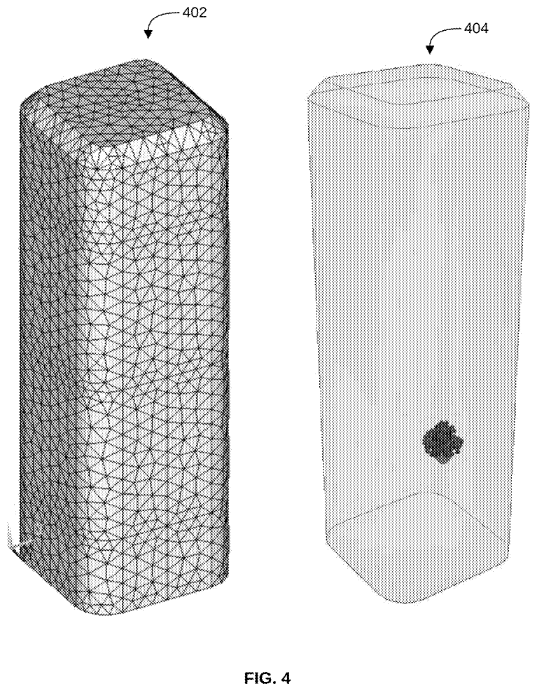

Operations of the block 310 include matching measurement point locations from a surface of the object (e.g., as defined by the damage profile) to corresponding locations in the background mesh. The background mesh has a fixed reference geometry that remains unchanged throughout the detection process. In some aspects, the background mesh is unstructured, for example, to accommodate a complex geometry of the object. For example, FIG. 4 illustrates a background mesh 402 and an object 404 according to aspects of the present disclosure. The background mesh 402 comprises an unstructured tetrahedral mesh that defines the fixed reference geometry used for mapping measurement point locations. The unstructured nature of the background mesh 402 allows the mesh to conform to complex geometries of the object 404, including curved surfaces and irregular boundaries. The object 404 includes an internal defect represented as a cluster of elements within the volume. During the operations of block 310, measurement points obtained from the surface of the object 404 are matched to corresponding locations within the background mesh 402, enabling the coordinate synchronization program 245 to process the measurement data for defect prediction.

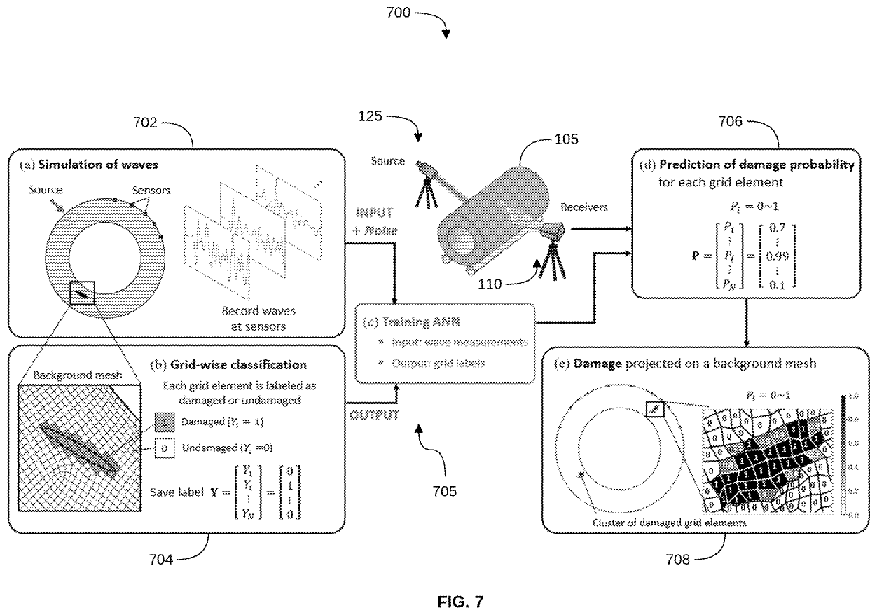

Returning to FIG. 3, in some examples, operations of the block 315 include dividing the background mesh into a plurality of grid elements and assigning a binary value to each grid element based on presence or absence of damage. The background mesh maintains its fixed reference geometry while the data generation process accommodates different damage profiles through adaptive mesh refinement in areas of interest. For finite element method (FEM) simulations, an adaptive mesh is first obtained. The adaptive mesh models the original defect's boundary, which is then mapped onto the fixed background mesh. Each grid element receives a label of 1 for damaged regions or 0 for undamaged regions, creating a binary classification across the entire mesh structure (see the method 500 for an example of preventing overfitting during the training by labeling each grid element as 0 or 1). For example, operations of the block 315 include generating a target label matrix Y=[Y₁, . . . , Yᵢ, . . . , Yₙ]^{T}, where each element Yᵢ represents a grid element's classification. A grid element receives Yᵢ=1 for damaged regions or Yᵢ=0 for undamaged regions. (See, for example, FIG. 7.)

Operations of the block 315 include converting the binary classification into a continuous probability value based on a distance between each of the plurality of grid elements and a damage location in the background mesh to generate a training matrix. The continuous probability values indicate the likelihood of damage at different locations in the background mesh.

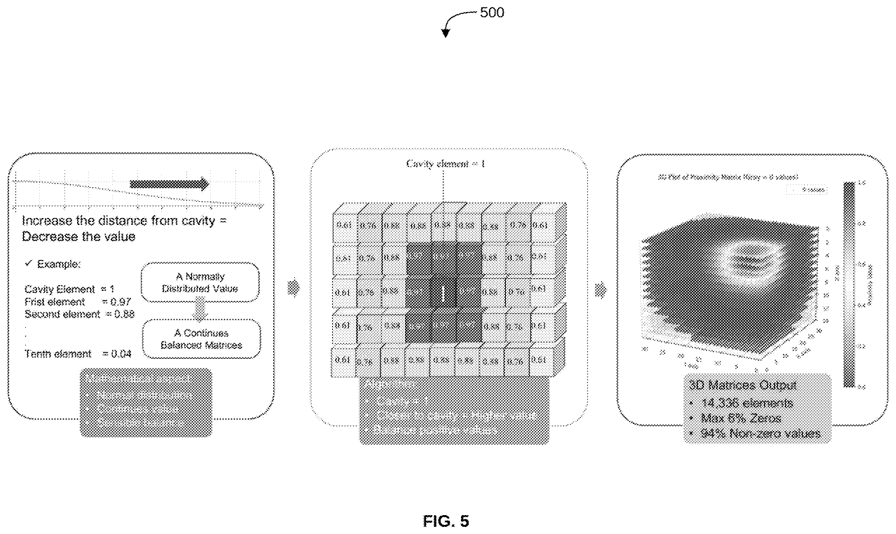

In some examples, the conversion process assigns higher probability values to grid elements closer to grid elements having a binary classification indicating damage. The conversion applies a normal distribution to generate the continuous probability values. For each grid element, the probability value decreases as the distance from damaged elements increases. The probability values range from 0 to 1, where Pᵢ represents the predicted probability at the i-th grid element. For example, the resulting probability distribution creates a gradient effect, with values like 0.99 near damage locations decreasing to 0.7, 0.3, and 0.1 as distance increases. For example, as shown in FIG. 5, the conversion process includes generating a target label matrix Y=[Y₁, . . . , Yᵢ, . . . , Yₙ]^{T} and converting it to a proximity matrix, where grid elements near damage locations receive higher probability values such as 0.99, while grid elements farther from damage locations receive lower values such as 0.7, 0.3, and 0.1, creating a continuous gradient across the background mesh that indicates the likelihood of damage at each location.

Operations of the block 320 include training an artificial neural network (ANN) using a training dataset including the training matrix. In some examples, training the ANN comprises generating multiple damage profiles by simulating wave responses using the background mesh with the fixed reference geometry. The training generates a plurality of training matrices by mapping each of the multiple damage profiles onto the background mesh. The ANN training uses these matrices to learn patterns of damage distribution. The training dataset maintains computational consistency by using the same background mesh structure across all simulations while capturing diverse damage scenarios. In some aspects, noise is added to the input feature data for the training dataset. An example of ANN training is described below with respect to FIG. 7.

Operations of the block 325 include receiving measurement data of points from the surface of the object and predict, using the trained ANN, the defect in the background mesh based on the measurement data. In some examples, the prediction triggers the system 100 to transmit control signals for managing a manufacturing process or to transmit notification signals indicating a defect. For example, the system 100 may transmit control signals via a wired connection or wirelessly (e.g., using an industrial fieldbus protocol) to a manufacturing line to halt production, divert a defective part to a rejection bin, adjust manufacturing parameters such as temperature or pressure, or initiate a secondary inspection process. In some instances, the system 100 transmits notification signals to an operator via a display interface showing the predicted defect location and probability values, an audible alarm indicating detection of a defect above a threshold probability, an electronic message sent to a quality control workstation, or a log entry recorded in a manufacturing execution system for traceability purposes.

FIG. 5 illustrates an example method 500 for preventing overfitting during the training, according to some examples. The method 500 addresses the challenge of imbalanced training data that arises when binary classifications are used directly for training the ANN. In typical damage scenarios, the number of undamaged grid elements significantly exceeds the number of damaged grid elements, which can cause the ANN to overfit toward predicting undamaged regions. The method 500 converts the binary classifications into continuous probability values to create a more balanced training matrix.

In the method 500, a cavity element representing a damaged region receives a value of 1. Grid elements adjacent to the cavity element receive probability values that decrease based on their distance from the damage location. For example, a first adjacent element receives a value of 0.97, a second element receives a value of 0.88, and a tenth element receives a value of 0.04. The method 500 applies a normal distribution to generate these continuous probability values, resulting in a gradient effect across the background mesh.

The method 500 produces a proximity matrix where the cavity element at the center is assigned a value of 1, and surrounding grid elements receive decreasing values such as 0.97, 0.88, 0.76, and 0.61 based on their distance from the cavity. This approach generates continuous balanced matrices where elements closer to the cavity receive higher values and positive values are distributed throughout the mesh. As illustrated, in some examples, the resulting training matrix comprises 94 percent non-zero values and a maximum of 6 percent zeros, confirming the balanced nature of the generated training data. The balanced distribution of values prevents the ANN from overfitting toward undamaged predictions.

FIG. 7 illustrates a method 700 for training an artificial neural network and predicting defects according to aspects of the present disclosure. The method 700 comprises a wave simulation 702 that simulates wave propagation through a structure containing defects and records wave responses at sensor locations, as described herein. A grid-wise classification 704 maps damage profiles onto a background mesh and labels each grid element as damaged or undamaged, as described with respect to block 315. A training 705 stage trains the ANN using the simulated wave measurements as input features and the grid-wise labels as output targets. In some aspects, noise is added to the input feature data during training 705 to improve prediction performance under noisy measurement conditions. Adding noise to the training data improves the robustness of the trained ANN when processing real-world measurement data that may contain noise from environmental factors or measurement equipment. A damage prediction 706 outputs a predicted probability vector where each element represents the likelihood of damage at a corresponding grid element, as described with respect to block 325. A damage projection 708 projects the predicted damage onto the background mesh, identifying clusters of damaged grid elements within the structure, as described with respect to block 325.

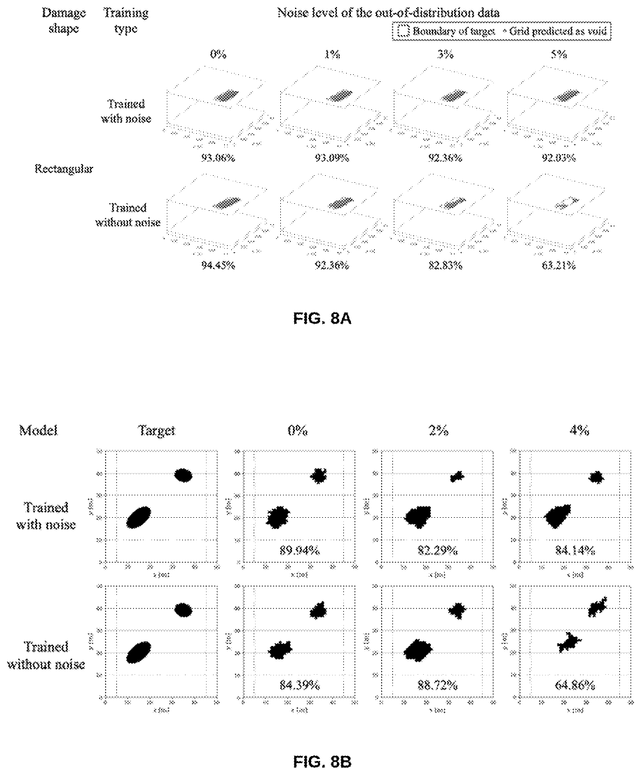

FIGS. 8A and 8B illustrate a comparison of defect detection performance between models trained with noise and models trained without noise according to aspects of the present disclosure. FIG. 8A presents results for a rectangular damage shape tested across noise levels of 0%, 1%, 3%, and 5% of out-of-distribution data. The model trained with noise maintains relatively stable detection accuracy across all noise levels, achieving 93.06% at 0% noise and 92.03% at 5% noise. In contrast, the model trained without noise demonstrates significant accuracy degradation as noise levels increase, dropping from 94.45% at 0% noise to 63.21% at 5% noise. FIG. 8B presents results for two elliptical damage shapes tested across noise levels of 0%, 2%, and 4% of out-of-distribution data. The model trained with noise achieves detection accuracies of 89.94% at 0% noise and 84.14% at 4% noise, while the model trained without noise shows increased dispersion and fragmentation of predicted damage regions at higher noise levels, with accuracy dropping to 64.86% at 4% noise. The comparison across both sub-figures demonstrates that adding noise to the input feature data during training 705, as described with respect to FIG. 7, improves prediction robustness when processing measurement data containing noise from environmental factors or measurement equipment.

Examples provided herein refer to an artificial neural network (ANN) 225. In some examples, the artificial neural network (ANN) comprises a feedforward neural network including one or more fully connected hidden layers. In such examples, input feature data derived from the guided wave measurements is provided as a feature vector to an input layer, processed through one or more hidden layers using nonlinear activation functions, and output as probability values corresponding to respective grid elements of the background mesh.

In other examples, the ANN comprises a convolutional neural network (CNN) configured to process spatially correlated input features. For example, measurement data mapped to locations on the background mesh may be arranged as a multi-dimensional tensor, and convolutional layers may be applied to extract spatial patterns associated with defect-induced wave propagation characteristics prior to generating probability values for damaged grid elements.

In further examples, the ANN comprises a graph-based neural network, such as a graph convolutional network (GCN), in which grid elements of the background mesh are treated as nodes of a graph and adjacency relationships between grid elements define graph edges. In such examples, the ANN propagates information between neighboring grid elements to account for spatial relationships within the unstructured background mesh when predicting damage probabilities.

In still further examples, the ANN comprises a recurrent neural network (RNN) or a long short-term memory (LSTM) network configured to process time-domain guided wave signals. In such examples, temporal features extracted from the measurement data are learned by the ANN prior to mapping predicted damage probabilities to corresponding grid elements of the background mesh.

It will be appreciated that the ANN architecture may include any combination of the foregoing network types, and may further include normalization layers, pooling layers, skip connections, or other architectural components suitable for learning relationships between guided wave measurement data and damage distributions within the background mesh. The specific ANN architecture, number of layers, and training parameters may be selected based on the geometry of the object, the resolution of the background mesh, and the characteristics of the measurement data, without departing from the scope of the present disclosure.

As should be apparent from this detailed description above, the operations and functions of the electronic computing device are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot transmit or receive electronic messages, electronically encoded video, electronically encoded audio, etc., and cannot register to push-to-talk communication networks, among other features and functions set forth herein).

In the foregoing specification, various examples have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “includes,” “containing,” or any other variation thereof, are intended to cover a non-exclusive inclusion, such that a process, method, article, or apparatus that comprises, has, includes, includes a list of elements does not include only those elements but may include other elements not expressly listed or inherent to such process, method, article, or apparatus. An element proceeded by “comprises . . . a,” “has . . . a,” “includes . . . a,” “includes . . . a” does not, without more constraints, preclude the existence of additional identical elements in the process, method, article, or apparatus that comprises, has, includes, includes the element. Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

Also, it should be understood that the illustrated components, unless explicitly described to the contrary, may be combined or divided into separate software, firmware, and/or hardware. For example, instead of being located within and performed by a single electronic processor, logic and processing described herein may be distributed among multiple electronic processors. Similarly, one or more memory modules and communication channels or networks may be used even if examples described or illustrated herein have a single such device or element. Also, regardless of how they are combined or divided, hardware and software components may be located on the same computing device or may be distributed among multiple different devices. Accordingly, in this description and in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

It will be appreciated that some examples may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an example can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

The terms “substantially,” “essentially,” “approximately,” “about” or any other version thereof, are defined as being close to as understood by one of ordinary skill in the art, and in one non-limiting example the term is defined to be within 10%, in another example within 5%, in another example within 1% and in another example within 0.5%. The term “one of,” without a more limiting modifier such as “only one of,” and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way but may also be configured in ways that are not listed.

The terms “coupled,” “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical element depending on the particular context.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

We claim:

1. A computer-implemented method for detecting a defect in an object, comprising:
characterizing an excitation force profile by determining a temporal and spatial distribution of the excitation force profile;
matching a measurement point's location from a surface of the object to a corresponding location in a background mesh, wherein the background mesh has a fixed reference geometry;
mapping a damage profile of a training data object onto a volume of the training data object's background mesh to generate a binary classification for each of a plurality of grid elements of the background mesh;
converting the binary classification into a continuous probability value based on a distance between each of the plurality of grid elements and a damage location within the background mesh to generate a training matrix;
training an artificial neural network (ANN) using a training dataset including the training matrix;
receiving measurement data of points from the surface of the object corresponding to locations in the background mesh; and
predicting, via the trained ANN, the defect as a group of damaged elements within the background mesh based on the measurement data.

2. The computer-implemented method of claim 1, wherein obtaining the damage profile comprises:
applying an excitation signal to the object;
obtaining a wave response from the object in response to the excitation signal; and
determining an excitation force profile based on the wave response to generate the damage profile.

3. The computer-implemented method of claim 2, wherein determining the excitation force profile comprises:
applying machine learning or a full-waveform source inversion to iteratively adjust predicted wave responses; and
determining the excitation force profile by substantially minimizing a difference between the predicted wave responses and the wave response from the object.

4. The computer-implemented method of claim 1, wherein mapping the damage profile comprises:
labeling each of the plurality of grid elements by assigning a binary value to each of the plurality of grid elements based on presence or absence of damage.

5. The computer-implemented method of claim 1, wherein converting the binary classification comprises:
assigning a higher probability value to a grid element closer to a grid element having a binary classification indicating damage; and
generating the continuous probability value by applying a normal distribution to the higher probability value.

6. The computer-implemented method of claim 1, wherein a continuous probability value decrease when the respective distance from the damage location increases.

7. The computer-implemented method of claim 1, wherein training the artificial neural network comprises:
obtaining a plurality of damage profiles;
generating a plurality of training matrices by mapping each of the plurality of damage profiles onto the background mesh; and
training the ANN based on the plurality of training matrices.

8. The computer-implemented method of claim 1, wherein the background mesh is unstructured to accommodate a complex geometry of the object.

9. The computer-implemented method of claim 1, wherein the training dataset includes input feature data comprising added noise.

10. An apparatus for detecting a defect in an object, comprising:
an electronic processor configured to:
characterize an excitation force profile by determining a temporal and spatial distribution of the excitation force profile;
match a measurement point's location from a surface of the object to a corresponding location in a background mesh, wherein the background mesh has a fixed reference geometry;
map a damage profile of a training data object onto a volume of the training data object's background mesh to generate a binary classification for each of a plurality of grid elements of the background mesh;
convert the binary classification into a continuous probability value based on a distance between each of the plurality of grid elements and a damage location within the background mesh to generate a training matrix;
train an artificial neural network (ANN) using a training dataset including the training matrix;
receive measurement data of points from the surface of the object corresponding to locations in the background mesh; and
predict, via the trained ANN, the defect as a group of damaged elements within the background mesh based on the measurement data.

11. The apparatus of claim 10, wherein to obtain the damage profile, the electronic processor is configured to:
apply an excitation signal to the object;
obtain a wave response from the object in response to the excitation signal; and determine an excitation force profile based on the wave response.

12. The apparatus of claim 11, wherein to determine the excitation force profile, the electronic processor is configured to:
apply machine learning or a full-waveform source inversion to iteratively adjust predicted wave responses; and
determine the excitation force profile by substantially minimizing a difference between the predicted wave responses and the wave response from the object.

13. The apparatus of claim 10, wherein to map the damage profile, the electronic processor is configured to:
label each of the plurality of grid elements by assigning a binary value to each of the plurality of grid elements based on presence or absence of damage.

14. The apparatus of claim 10, wherein to convert the binary classification, the electronic processor is configured to:
assign a higher probability value to a grid element closer to a grid element having a binary classification indicating damage; and
generate the continuous probability value by applying a normal distribution to the higher probability value.

15. The apparatus of claim 10, wherein a continuous probability value decreases when the respective distance from the damage location increases.

16. The apparatus of claim 10, wherein to train the ANN, the electronic processor is configured to:
obtain a plurality of damage profiles;
generate a plurality of training matrices by mapping each of the plurality of damage profiles onto the background mesh; and
train the ANN based on the plurality of training matrices.

17. The apparatus of claim 10, wherein the background mesh is unstructured to accommodate a complex geometry of the object.

18. The apparatus of claim 10, wherein the training dataset includes input feature data comprising added noise.

19. A non-transitory computer-readable medium storing instructions for detecting a defect in an object, wherein the instructions when executed by a computer, cause the computer to:
characterize an excitation force profile by determining a temporal and spatial distribution of the excitation force profile;
match a measurement point's location from a surface of the object to a corresponding location in a background mesh, wherein the background mesh has a fixed reference geometry;
map a damage profile of a training data object onto a volume of the training data object's background mesh to generate a binary classification for each of a plurality of grid elements of the background mesh;
convert the binary classification into a continuous probability value based on a distance between each of the plurality of grid elements and a damage location within the background mesh to generate a training matrix;
train an artificial neural network (ANN) using a training dataset including the training matrix;
receive measurement data of points from the surface of the object corresponding to locations in the background mesh; and
predict, via the trained ANN, the defect as a group of damaged elements within the background mesh based on the measurement data.

20. The non-transitory computer-readable medium of claim 19, wherein to obtain the damage profile, the non-transitory computer-readable medium storing further instructions, the further instructions, when executed by the computer, cause the computer to:
apply an excitation signal to the object;
obtain a wave response from the object in response to the excitation signal; and
determine an excitation force profile based on the wave response.
